(19) United States
(12) Patent Application Publication
(10) Pub. No.: US 2026/0111281 A1
(43) Pub. Date: Apr. 23, 2026

(54) COMPUTING SYSTEM AND METHOD WITH WORKLOAD AWARE DYNAMIC LOAD BALANCER

(71) Applicant: International Business Machines Corporation, Armonk, NY (US)

(72) Inventors: Adrian C. Gerhard, Rochester, MN (US); Brian Bakke, Rochester, MN (US)

(21) Appl. No.: 18/924,717

(22) Filed: Oct. 23, 2024

(51) Int. Cl. G06F 9/50

(52) U.S. Cl. CPC G06F 9/505

(57) ABSTRACT

According to one aspect, a method includes identifying a plurality of workloads for processing by a plurality of cores, the workloads having attributes associated therewith. The attributes include whether the associated workload is movable or non-movable. The attributes also include indicators of resource utilizations of the workloads. A determination is made as to whether one of the cores is considered underutilized based on predefined criteria (as described in more detail below). In response to determining that a first of the cores is considered underutilized, a load balancer is run on the first core. The load balancer performs a check to determine whether to move a workload from one of the cores to another of the cores. In response to the load balancer determining to move one of the workloads from one of the cores to another of the cores, at least a portion of the workload is moved to another of the cores.

### BACKGROUND

The present invention relates to load balancing between computing cores, and more specifically, this invention relates to dynamic load balancing in response to changing demand, while keeping workloads separated and operating efficiently in terms of instruction and data cache usage.

With multiple processing cores, e.g., multiple cores within a discrete processor, multiple discrete processors in a cluster, or a combination of both, most systems fall into one of two categories: symmetric multiprocessing (SMP) and asymmetric multiprocessing (AMP).

SMP is often used because of its versatility. SMP ensures that every core gets used, and in a busy or maxed out system, no compute resources are left unused. This is very common in multipurpose or general use systems where workloads are not understood, e.g., the computer does not know what types of workloads will be running thereon. The downside of SMP is that workloads can conflict, causing instruction cache spill and even data cache overflow, depending on workloads. SMP also requires use of locks or other methods of SMP safe programming to ensure data that could be used on multiple cores is protected. Both of these things can cause SMP systems to perform worse per core, but usually the overall system benefits from fully utilizing more cores.

AMP is sometimes used when workloads are well understood. A well understood workload may be a workload that is specific to the type of system. For example, an ethernet router routes packets, so all workloads therein deal with routing the packets and the workloads being used will not change over time. A well understood workload may also be one in which the attributes of the workload are known, predefined, discovered, etc. Workloads in embedded systems are typically well understood.

With AMP, certain workloads are pinned to certain cores. This ensures efficient instruction cache usage, and usually benefits data cache because fewer types of work generally touches less data. This often reduces the need for locks and other data protection if it is known that certain data is only touched on one core. AMP is often used on embedded systems or appliances with very stable and well understood workloads. One downside for AMP is that if the workloads that are in use are not well balanced, a system could be fully utilized but one or even many cores can be nearly idle. This results in efficient per core use, but overall system utilization may be very inefficient.

For workloads that are well balanced and very stable, AMP is a good choice. For very homogeneous workloads, both AMP or SMP can be almost equivalent and both are well suited. For dynamic workloads, AMP often is not used because many cores are not used efficiently, or sometimes even at all. For these workloads, SMP is usually used, as it can adapt dynamically and adjust to the changing demands. However, in these workloads, cache inefficiencies and locking overhead is often a necessary overhead, reducing performance.

### SUMMARY

According to one aspect of the present invention, a method includes identifying a plurality of workloads for processing by a plurality of cores, the workloads having attributes associated therewith. The attributes include whether the associated workload is movable or non-movable. The attributes also include indicators of resource utilizations of the workloads. A determination is made as to whether one of the cores is considered underutilized based on predefined criteria (as described in more detail below). In response to determining that a first of the cores is considered underutilized, a load balancer is run on the first core. The load balancer performs a check to determine whether to move a workload from one of the cores to another of the cores. In response to the load balancer determining to move one of the workloads from one of the cores to another of the cores, at least a portion of the workload is moved to another of the cores.

A computer program product, in accordance with one aspect of the present invention, includes one or more computer-readable storage media, and program instructions stored on the one or more storage media to perform operations that include identifying a plurality of workloads for processing by a plurality of cores, the workloads having attributes associated therewith. The attributes include whether the associated workload is movable or non-movable. The attributes also include indicators of resource utilizations of the workloads. A determination is made as to whether one of the cores is considered underutilized based on predefined criteria. In response to determining that a first of the cores is considered underutilized, a load balancer is run on the first core. The load balancer performs a check to determine whether to move a workload from one of the cores to another of the cores. In response to the load balancer determining to move one of the workloads from one of the cores to another of the cores, at least a portion of the workload is moved to another of the cores.

A computer system, in accordance with one aspect of the present invention, includes a processor set, one or more computer-readable storage media, and program instructions stored on the one or more storage media to cause the processor set to perform operations that include identifying a plurality of workloads for processing by a plurality of cores, the workloads having attributes associated therewith. The attributes include whether the associated workload is movable or non-movable. The attributes also include indicators of resource utilizations of the workloads. A determination is made as to whether one of the cores is considered underutilized based on predefined criteria. In response to determining that a first of the cores is considered underutilized, a load balancer is run on the first core. The load balancer performs a check to determine whether to move a workload from one of the cores to another of the cores. In response to the load balancer determining to move one of the workloads from one of the cores to another of the cores, at least a portion of the workload is moved to another of the cores.

A method, in accordance with one aspect of the present invention, includes identifying a plurality of workloads for processing by a plurality of cores, the workloads having attributes associated therewith, the attributes including whether the associated workload is movable or non-movable, the attributes including whether the associated workload is cache friendly or cache unfriendly. A determination is made as to whether one of the cores is considered underutilized based on predefined criteria. In response to determining none of the cores is considered underutilized based on the predefined criteria, the load balancer is not run, regardless of an amount of time since the load balancer was last run. A lock is placed on the load balancer while the load balancer is running on the first core. The load balancer performs a check to determine whether to move a workload from one of the cores to another of the cores. In response to the load balancer determining to move one of the workloads from one of the cores to another of the cores, at least a portion of the workload is moved to another of the cores. The load balancer does not rebalance workloads more frequently than a predefined time duration. The workloads with certain attributes are pinned to a common one of the cores. No core is assigned both the cache friendly workloads and the cache unfriendly workloads by the load balancer.

A computer program product, in accordance with one aspect of the present invention, includes identifying a plurality of workloads for processing by a plurality of cores, the workloads having attributes associated therewith, the attributes including whether the associated workload is movable or non-movable, the attributes including whether the associated workload is cache friendly or cache unfriendly. A determination is made as to whether one of the cores is considered underutilized based on predefined criteria. In response to determining none of the cores is considered underutilized based on the predefined criteria, the load balancer is not run, regardless of an amount of time since the load balancer was last run. In response to determining that a first of the cores is considered underutilized, the load balancer is run on the first core. A lock is placed on the load balancer while the load balancer is running on the first core. The load balancer performs a check to determine whether to move a workload from one of the cores to another of the cores. In response to the load balancer determining to move one of the workloads from one of the cores to another of the cores, at least a portion of the workload is moved to another of the cores. The load balancer does not rebalance workloads more frequently than a predefined time duration. The workloads with certain attributes may be pinned to a common one of the cores. No core is assigned both the cache friendly workloads and the cache unfriendly workloads by the load balancer.

Other aspects of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one aspect of the present invention.

FIG. 2 is a diagram of a tiered data storage system, in accordance with one aspect of the present invention.

FIG. 3 is a flowchart of a method, in accordance with one approach.

FIG. 4 is a flowchart of a method, in accordance with one approach.

FIG. 5 is a flowchart of a method, in accordance with one approach.

FIG. 6 is a flowchart of a subprocess, in accordance with one approach.

FIG. 7 is a flowchart of a subprocess, in accordance with one approach.

FIG. 8 is a flowchart of a method, in accordance with one approach.

FIG. 9 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches for systems, methods, and computer program products for dynamic load balancing in response to changing demand, while keeping workloads separated and operating efficiently in terms of instruction and data cache usage. Various aspects described herein are particularly useful in a system with dynamically changing heterogeneous workloads that are well understood. Moreover, in some approaches, work (and thus the corresponding workload) is allowed to be pinned to cores in a similar manner as AMP, while also allowing workloads to be dynamically moved between cores. When workloads are moved between cores, they may be moved accounting for cache usage and are moved based on workload rather than simply placing the next piece of work in the first open spot. The approaches described herein provide efficient single CPU or cluster usage while still utilizing every core. Various approaches described herein also allow workloads that function best on a single core to operate on a single core, thus avoiding locking overhead. One significance of this is that it allows AMP-like maximum performance, but across varying workloads with SMP-like multi core utilization. Also note that various aspects described herein are not applicable in all computing cases, but rather only apply where the workloads are well understood; thus various aspects described herein could not replace SMP on a general purpose system. However, for the many appliances or embedded systems that know what workloads to expect, but the distribution of the workloads vary, approaches described herein enable significantly better performance than a comparable system not implementing aspects described herein. To exemplify, an experiment conducted by the inventors revealed that, upon implementing the methodology presented herein in a storage controller, the caching impacts gave over a 2× performance delta relative to the performance of the storage controller prior to implementation of the methodology therein.

Workloads may generally refer to the types of work that the system is processing. Workloads may also refer to the types of work that is requested from a host. Reference to work herein generally corresponds to the workload that performs the work.

According to an aspect of the invention, there is provided a method that includes identifying a plurality of workloads for processing by a plurality of cores, the workloads having attributes associated therewith. The attributes include whether the associated workload is movable or non-movable. The attributes also include indicators of resource utilizations of the workloads. A determination is made as to whether one of the cores is considered underutilized based on predefined criteria (as described in more detail below). In response to determining that a first of the cores is considered underutilized, a load balancer is run on the first core. The load balancer performs a check to determine whether to move a workload from one of the cores to another of the cores. In response to the load balancer determining to move one of the workloads from one of the cores to another of the cores, at least a portion of the workload is moved to another of the cores. A technical effect of the present method is to allow dynamic balancing in response to changing demand while keeping workloads separated and operating efficiently in terms of resource usage.

In some approaches, the load balancer does not rebalance workloads more frequently than a predefined time duration corresponding to multiple clock cycles, e.g., 10 ms, 100 ms, 500 ms, etc. For instance, even if a core is considered underutilized, a check may be performed to determine whether enough time has passed since the load balancer was last run, to thereby minimize the effect on performance. Less frequent checking of and/or by the load balancer improves performance by not using the resources that would otherwise be required to fully run the load balancer.

In some approaches, in response to determining that none of the cores was considered underutilized during a second predefined time duration, one of the cores may be selected and the load balancer run on the selected core in response to the second predefined time duration elapsing. A technical effect of this is that the load balancer can be checked at least periodically to determine whether any rebalancing would be beneficial, e.g., to improve system performance.

In some approaches, in response to determining none of the cores is considered underutilized based on the predefined criteria, the load balancer is not run, regardless of an amount of time since the load balancer was last run on any core. This has the technical effect of minimizing impact on the processing by the system. This feature may assume that if no core is sufficiently underutilized, then all cores are sufficiently busy, and thus no rebalancing is needed.

In some approaches, some workloads with certain attributes, e.g., the workloads are better optimized to run on a single core or run more efficiently sharing a single core with other similar workloads, are pinned to a common one of the cores. The workloads pinned to the common core may be workloads that run infrequently or may not be performance sensitive and thus may benefit from running on a single core rather than being optimized to run on multiple cores. A technical effect of this feature is that the code for implementing the methodology is greatly simplified, e.g., the code for the workload does not need to be made capable of, or optimized for, running on multiple cores. In addition, such consolidation improves system performance when the individual workloads are not optimized to run on multiple cores. By consolidating the workloads all on to one core, it is assured that the workloads are running “single threaded” which in turn provides the data protection that might otherwise need to be provided if the workloads were allowed to run on multiple cores. Note that in some cases, the consolidated workloads do consume a significant amount of the core they are relegated to, but usually not for a significant amount of time.

In some approaches, other workloads are also assigned to the common core during a balancing operation. The pinned workloads remain pinned to the common core, but the common core is also used to process additional workloads, improving overall performance of the system, relative to a scenario where the common core is not allowed to process workloads that are not pinned thereto.

In some approaches, a lock is placed on the load balancer while the load balancer is running on the first core. A technical effect of this feature is that if another core is also underutilized and attempts to check the load balancer, it will see that this lock is held and preferably skip the attempt altogether. This improves system performance and lowers power consumption by preventing other cores from running the load balancer, thereby keeping the other cores free to perform other functions.

In some approaches, the checking by the load balancer includes determining a total idle time for the first core, determining ratios of idle times to real working times for the respective types of workloads, selecting the smallest ratio, scaling the idle time for the type of workload corresponding to the smallest ratio up to correspond to a sampling period over which the total idle time was sampled, determining whether the scaled idle time is lower than the total idle time, and in response to the scaled idle time being lower than the total idle time, adjusting the total idle time down to be closer to or match the scaled idle time. This feature has the technical effect of more accurately determining whether a core is truly underutilized. If multiple types of work are assigned to a core, the idle time is essentially the sum of all the idle time from each type of work. However, if the idle time for a given type of work is very low, the idle time from some other workload might be seen as idle time on this core, resulting in an indication that the core is more idle than it really is. This feature alleviates this problem.

In some approaches, the indicators of resource utilizations of the workloads indicate whether the associated workloads are cache friendly or cache unfriendly. No core is assigned both the cache friendly workloads and the cache unfriendly workloads by the load balancer. For example, the load balancer may be configured to not assign both types of workloads to the same core. This has the technical effect of reducing instances where a cache unfriendly workload adversely affects cache friendly workloads on the same core by causing the cache to evict cached data, e.g., overflowing the cache, and thus the cache friendly workload has to fetch requisite data such as control blocks into cache again. As is well known, having to fetch things into cache over and over again takes considerably longer.

In some approaches, the checking by the load balancer includes calculating an average utilization of the cores processing the cache friendly workloads, calculating an average utilization of the cores processing the cache unfriendly workloads, and determining whether the average utilizations are below a predefined threshold. In response to determining that both utilizations are below the predefined threshold, no change is made to the workloads. In response to determining that one of the utilizations is above the predefined threshold, a determination is made as to whether all of the cores corresponding to the utilization above the predefined threshold have workloads assigned thereto. In response to determining that all of the cores corresponding to the utilization above the predefined threshold have workloads assigned thereto, a determination is made as to whether a difference (delta) between a utilization of a busiest of the cores corresponding to the utilization above the predefined threshold and a utilization of a least busy of the cores corresponding to the utilization above the predefined threshold exceeds a second predefined threshold. In response to determining that the difference exceeds the second predefined threshold, a determination is made to move one or more of the workloads, preferably from the busiest core to another core, e.g., the least busy core, in portions to multiple less busy cores, etc. This has the technical effect of preventing the highest utilized core from being converted to the new lowest utilized core, and avoids incurring the overhead and processing delays associated with moving a workload from one core to another if little to no improvement to system performance would be gained by the move.

In some approaches, in response to determining to move one or more of the workloads, a determination is made as to how many types of the movable workloads are on the busiest of the cores. In response to determining that a number of types of the movable workloads on the busiest of the cores is at least two or that a number of types of movable workloads on the busiest core is at least one and that at least some non-movable work is also assigned on the busiest of the core, the type of the movable workloads having the lowest processing time on the busiest of the cores is selected. A determination is made as to whether moving the type of the movable workload having the lowest processing time on the busiest of the cores to the least busy of the cores would result in the least busy of the cores being busier than the busiest of the cores after the move. In response to determining that the least busy of the cores would be busier than the busiest of the cores after the move, the type of the movable workload having the lowest processing time on the busiest of the cores is not moved. In response to determining that the least busy of the cores would not be busier than the busiest of the cores after the move, the type of the movable workload having the lowest processing time on the busiest of the cores is moved to the least busy of the cores. This has the technical effect of preventing the highest utilized core from being converted to the new lowest utilized core, and avoids incurring the overhead and processing delays associated with moving a workload from one core to another.

In some approaches, in response to determining to move one or more of the workloads, a determination is made as to how many types of the movable workloads are on the busiest of the cores. In response to determining that a number of types of the movable workloads on the busiest of the cores is one, at least one of the movable workloads is moved, or spread, to at least one other core. This has the technical effect of improving overall system performance by reducing the load on the initial core, and resulting in faster processing of the moved workload by the less busy core.

In some approaches, the checking by the load balancer includes attempting to coalesce at least some of the movable workloads. The checking includes assessing the types of movable workloads that are assigned to multiple cores for determining which type of workload can be coalesced to fewer of the cores and result in the lowest utilization of a busiest of the fewer cores after coalescence. Based on the assessment, the workloads of the determined type are coalesced to the fewer of the cores. This has the technical effect of releasing one or more of the cores for use in processing other workloads.

In some aspects of the present invention, a plurality of the foregoing approaches are combined, in any possible combination, to technical aspects and advantages of the aforementioned approaches.

A computer program product, in accordance with one aspect of the present invention, includes one or more computer-readable storage media, and program instructions stored on the one or more storage media to perform operations that include identifying a plurality of workloads for processing by a plurality of cores, the workloads having attributes associated therewith. The attributes include whether the associated workload is movable or non-movable. The attributes also include indicators of resource utilizations of the workloads. A determination is made as to whether one of the cores is considered underutilized based on predefined criteria. In response to determining that a first of the cores is considered underutilized, a load balancer is run on the first core. The load balancer performs a check to determine whether to move a workload from one of the cores to another of the cores. In response to the load balancer determining to move one of the workloads from one of the cores to another of the cores, at least a portion of the workload is moved to another of the cores, e.g., the workload remains on the busiest core and is also spread to another core or cores (a portion of the workload running on that core is moved), or the workload is moved off of the busiest core to one or more other cores (all portions of the workload running on that core are moved). A technical effect of the present method is to allow dynamic balancing in response to changing demand while keeping workloads separated and operating efficiently in terms of resource usage.

In some approaches, the load balancer does not rebalance workloads more frequently than a predefined time duration corresponding to multiple clock cycles, e.g., 10 ms, 100 ms, 500 ms, etc. For instance, even if a core is considered underutilized, a check may be performed to determine whether enough time has passed since the load balancer was last run, to thereby minimize the effect on performance. Less frequent checking of and/or by the load balancer improves performance by not using the resources that would otherwise be required to fully run the load balancer.

In some approaches, in response to determining that none of the cores was considered underutilized during a second predefined time duration, one of the cores may be selected and the load balancer run on the selected core in response to the second predefined time duration elapsing. A technical effect of this is that the load balancer can be checked at least periodically to determine whether any rebalancing would be beneficial, e.g., to improve system performance.

In some approaches, in response to determining none of the cores is considered underutilized based on the predefined criteria, the load balancer is not run, regardless of an amount of time since the load balancer was last run on any core. This has the technical effect of minimizing impact on the processing by the system. This feature may assume that if no core is sufficiently underutilized, then all cores are sufficiently busy, and thus no rebalancing is needed.

In some approaches, some workloads with certain attributes, e.g., they are better optimized to run on a single core or run more efficiently sharing a single core with other similar workloads, are pinned to a common one of the cores. The workloads pinned to the common core may be workloads that run infrequently or may not be performance sensitive and thus may benefit from running on a single core rather than being optimized to run on multiple cores. A technical effect of this feature is that the code for implementing the methodology is greatly simplified, e.g., the code for the workload does not need to be made capable of, or optimized for, running on multiple cores. In addition, such consolidation improves system performance when the individual workloads are not optimized to run on multiple cores. By consolidating the workloads all on to one core, it is assured that the workloads are running “single threaded” which in turn provides the data protection that might otherwise need to be provided if the workloads were allowed to run on multiple cores. Note that in some cases, the consolidated workloads do consume a significant amount of the core they are relegated to, but usually not for a significant amount of time.

In some approaches, other workloads are also assigned to the common core during a balancing operation. The pinned workloads remain pinned to the common core, but the common core is also used to process additional workloads, improving overall performance of the system, relative to a scenario where the common core is not allowed to process workloads that are not pinned thereto.

In some approaches, a lock is placed on the load balancer while the load balancer is running on the first core. A technical effect of this feature is that if another core is also underutilized and attempts to check the load balancer, it will see that this lock is held and preferably skip the attempt altogether. This improves system performance and lowers power consumption by preventing other cores from running the load balancer, thereby keeping the other cores free to perform other functions.

In some approaches, the checking by the load balancer includes determining a total idle time for the first core, determining ratios of idle times to real working times for the respective types of workloads, selecting the smallest ratio, scaling the idle time for the type of workload corresponding to the smallest ratio up to correspond to a sampling period over which the total idle time was sampled, determining whether the scaled idle time is lower than the total idle time, and in response to the scaled idle time being lower than the total idle time, adjusting the total idle time down to be closer to or match the scaled idle time. This feature has the technical effect of more accurately determining whether a core is truly idle. If multiple types of work are assigned to a core, the idle time is essentially the sum of all the idle time from each type of work. However, if the idle time for a given type of work is very low, the idle time from some other workload might be seen as idle time on this core, resulting in an indication that the core is more idle than it really is. This feature alleviates this problem.

In some approaches, the attributes that are indicators of resource utilizations of the workloads indicate whether the associated workloads are cache friendly or cache unfriendly. No core is assigned both the cache friendly workloads and the cache unfriendly workloads by the load balancer. For example, the load balancer may be configured not to assign both types of workloads to the same core. This has the technical effect of reducing instances where a cache unfriendly workload adversely affects cache friendly workloads on the same core by causing the cache to evict cached data, e.g., overflowing the cache, and thus the cache friendly workload has to fetch all of its control blocks into cache again.

A computer system, in accordance with one aspect of the present invention, includes a processor set, one or more computer-readable storage media, and program instructions stored on the one or more storage media to cause the processor set to perform operations that include identifying a plurality of workloads for processing by a plurality of cores, the workloads having attributes associated therewith. The attributes include whether the associated workload is movable or non-movable. The attributes also include indicators of resource utilizations of the workloads. A determination is made as to whether one of the cores is considered underutilized based on predefined criteria. In response to determining that a first of the cores is considered underutilized, a load balancer is run on the first core. The load balancer performs a check to determine whether to move a workload from one of the cores to another of the cores. In response to the load balancer determining to move one of the workloads from one of the cores to another of the cores, at least a portion of the workload is moved to another of the cores. A technical effect of the present method is to allow dynamic balancing in response to changing demand while keeping workloads separated and operating efficiently in terms of resource usage.

In some approaches, the indicators of resource utilizations of the workloads indicate whether the associated workloads are cache friendly or cache unfriendly. No core is assigned both the cache friendly workloads and the cache unfriendly workloads by the load balancer. For example, the load balancer may be configured not to assign both types of workloads to the same core. This has the technical effect of reducing instances where a cache unfriendly workload adversely affects cache friendly workloads on the same core by causing the cache to evict cached data, e.g., overflowing the cache, and thus the cache friendly workload has to fetch all of its control blocks into cache again.

A method, in accordance with one aspect of the present invention, includes identifying a plurality of workloads for processing by a plurality of cores, the workloads having attributes associated therewith, the attributes including whether the associated workload is movable or non-movable, the attributes including whether the associated workload is cache friendly or cache unfriendly. A determination is made as to whether one of the cores is considered underutilized based on predefined criteria. In response to determining none of the cores is considered underutilized based on the predefined criteria, the load balancer is not run, regardless of an amount of time since the load balancer was last run. This has the technical effect of minimizing impact on the processing by the system. This feature may assume that if no core is sufficiently underutilized, then all cores are sufficiently busy, and thus no rebalancing is needed. In response to determining that a first of the cores is considered underutilized, the load balancer is run on the first core. A lock is placed on the load balancer while the load balancer is running on the first core. A technical effect of this feature is that if another core is also underutilized and attempts to check the load balancer, it will see that this lock is held and preferably skip the attempt altogether. This improves system performance and lowers power consumption by preventing other cores from running the load balancer, thereby keeping the other cores free to perform other functions. The load balancer performs a check to determine whether to move a workload from one of the cores to another of the cores. In response to the load balancer determining to move one of the workloads from one of the cores to another of the cores, at least a portion of the workload is moved to another of the cores. The load balancer does not rebalance workloads more frequently than a predefined time duration. Less frequent checking of and/or by the load balancer improves performance by not using the resources that would otherwise be required to fully run the load balancer. The workloads with certain attributes are pinned to a common one of the cores. These workloads may be run infrequently or may not be performance sensitive and thus may benefit from running on a single core rather than being optimized to run on multiple cores. A technical effect of this feature is that the code for implementing the methodology is greatly simplified. No core is assigned both the cache friendly workloads and the cache unfriendly workloads by the load balancer. This has the technical effect of reducing instances where a cache unfriendly workload adversely affects cache friendly workloads on the same core by causing the cache to evict cached data, e.g., overflowing the cache, and thus the cache friendly workload has to fetch all of its control blocks into cache again. A technical effect of the present method is to allow dynamic balancing in response to changing demand while keeping workloads separated and operating efficiently in terms of resource usage. In addition, consolidation of particular workloads onto a single core improves system performance when the individual workloads are not optimized to run on multiple cores. By consolidating these workloads on to one core, it is assured that the workloads are running “single threaded” which in turn provides the data protection that might otherwise need to be provided if the workloads were allowed to run on multiple cores.

A computer program product, in accordance with one aspect of the present invention, includes identifying a plurality of workloads for processing by a plurality of cores, the workloads having attributes associated therewith, the attributes including whether the associated workload is movable or non-movable, the attributes including whether the associated workload is cache friendly or cache unfriendly. A determination is made as to whether one of the cores is considered underutilized based on predefined criteria. In response to determining none of the cores is considered underutilized based on the predefined criteria, the load balancer is not run, regardless of an amount of time since the load balancer was last run. This has the technical effect of minimizing impact on the processing by the system. This feature may assume that if no core is sufficiently underutilized, then all cores are sufficiently busy, and thus no rebalancing is needed. In response to determining that a first of the cores is considered underutilized, the load balancer is run on the first core. A lock is placed on the load balancer while the load balancer is running on the first core. A technical effect of this feature is that if another core is also underutilized and attempts to check the load balancer, it will see that this lock is held and preferably skip the attempt altogether. This improves system performance and lowers power consumption by preventing other cores from running the load balancer, thereby keeping the other cores free to perform other functions. The load balancer performs a check to determine whether to move a workload from one of the cores to another of the cores. In response to the load balancer determining to move one of the workloads from one of the cores to another of the cores, at least a portion of the workload is moved to another of the cores. The load balancer does not rebalance workloads more frequently than a predefined time duration. Less frequent checking of and/or by the load balancer improves performance by not using the resources that would otherwise be required to fully run the load balancer. The workloads with certain attributes, e.g., are better optimized to run on a single core or run more efficiently sharing a single core with other similar workloads, may be pinned to a common one of the cores. These workloads may be run infrequently or may not be performance sensitive and thus may benefit from running on a single core rather than being optimized to run on multiple cores. At least some of the other workloads may remain movable to other cores including the common one of the cores. A technical effect of this feature is that the code for implementing the methodology is greatly simplified. No core is assigned both the cache friendly workloads and the cache unfriendly workloads by the load balancer. This has the technical effect of reducing instances where a cache unfriendly workload adversely affects cache friendly workloads on the same core by causing the cache to evict cached data, e.g., overflowing the cache, and thus the cache friendly workload has to fetch all of its control blocks into cache again. A technical effect of the present method is to allow dynamic balancing in response to changing demand while keeping workloads separated and operating efficiently in terms of resource usage. In addition, consolidation of particular workloads onto a single core improves system performance when the individual workloads are not optimized to run on multiple cores. By consolidating these workloads on to one core, it is assured that the workloads are running “single threaded” which in turn provides the data protection that might otherwise need to be provided if the workloads were allowed to run on multiple cores.

Various aspects of the present disclosure are described by narrative text, flowcharts, block diagrams of computer systems and/or block diagrams of the machine logic included in computer program product (CPP) aspects. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product aspect (“CPP aspect” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as performing dynamic workload balancing code 150. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

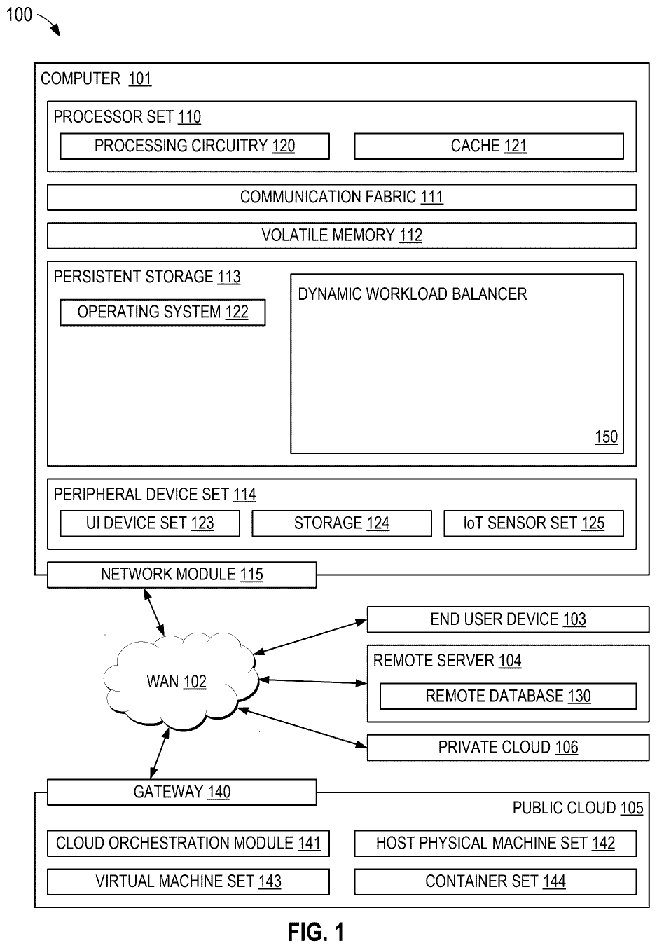

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

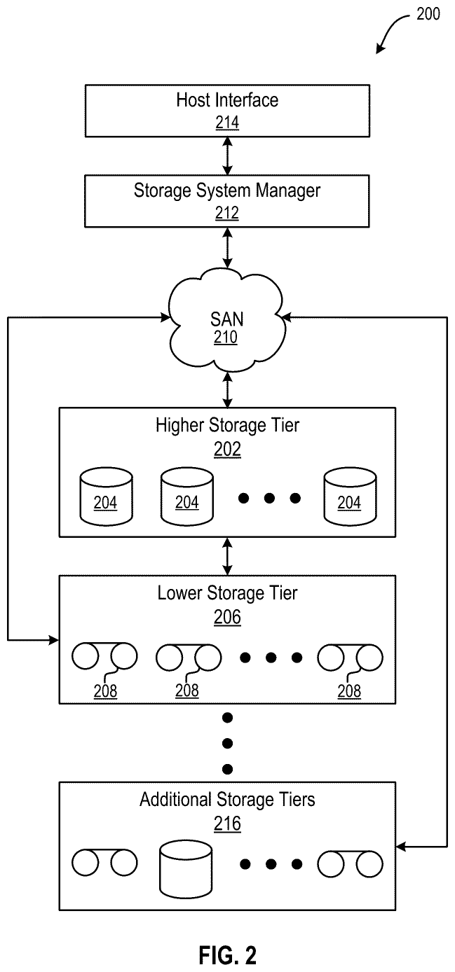

Now referring to FIG. 2, a storage system 200 is shown according to one aspect of the present invention. Note that some of the elements shown in FIG. 2 may be implemented as hardware and/or software, according to various approaches. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more approaches, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the approaches presented herein.

According to some approaches, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

Various aspects of the present invention are particularly useful in systems with dynamically changing heterogeneous workloads that are all well understood, such as within a data storage system such as storage system 200. For example, various approaches may be applied to the storage manager 202, the storage controllers of the various storage drives, etc. of the storage system 200. Implementation in storage hardware is used throughout the present description as an exemplary working example. Note, however, that this has been done by way of example only, and any of the approaches and aspects of the present invention described herein are usable in a plethora of scenarios with any type of hardware, including in processors of standalone hardware components; in processors and/or processor clusters of computers, servers, networking hardware, etc.; etc., as will become apparent in the following descriptions.

As will be described in more detail below, various aspects of the present invention include methodology for efficiently using cores in a multi-core device.

Further aspects of the present invention include methodology where workloads are characterized based on resource utilization footprint, e.g., cache footprint.

Further aspects of the present invention include methodology where workloads are assigned to a core based on homogeneous workload characteristics and isolation of heterogeneous workloads from each other.

Further aspects of the present invention include methodology where workloads are dynamically moved based on core utilization, demand, and changing workloads.

Further aspects of the present invention include a methodology where the balancing is performed on an underutilized core.

Further aspects of the present invention include methodology where work is coalesced to fewer cores when demand drops or cores are needed for other work.

Further aspects of the present invention include methodology where the balancing itself has minimal impact to system performance.

Yet further aspects of the present invention include methodology where the foregoing methodologies are combined in any possible combination.

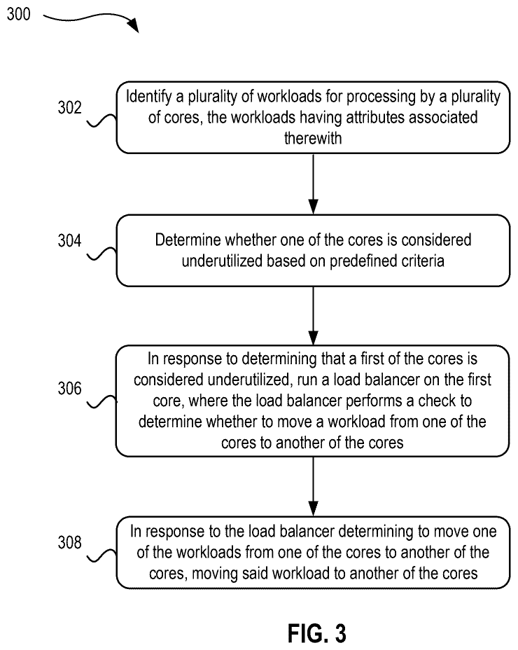

Now referring to FIG. 3, a flowchart of a method 300 is shown according to one approach. The method 300 may be performed in accordance with aspects of the present invention in any of the environments depicted in FIGS. 1-2, among others, in various approaches. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various approaches, the method 300 may be partially or entirely performed by a discrete processor having multiple cores, a cluster of discreet processors (preferably on a single board) where each processor is considered a core, a cluster of multi-core processors which act as a larger processor having a combination of the cores from multiple processors, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where a plurality of workloads for processing by a plurality of cores are identified. The workloads have attributes associated therewith. Illustrative attributes include whether the associated workload is movable or non-movable; indicators of resource utilizations of the respective workloads, e.g., cache utilization such as whether the workload is cache friendly or cache unfriendly; indicators of which workloads will adjust to use available processing time or have fixed amounts of processing per core; the type of the associated workload, e.g., each workload is associated with one of a plurality of predefined types of workloads; the types of instructions the workload does (e.g., loads and stores vs. register to register, etc.) ; etc.

In operation 304, a determination is made as to whether one of the cores is considered underutilized based on predefined criteria.

In operation 306, in response to determining that a first of the cores is considered underutilized, a load balancer is run on the first core. The load balancer performs a check to determine whether to move a workload from one of the cores to another of the cores.

In operation 308, in response to the load balancer determining to move one of the workloads from one of the cores to another of the cores, at least a portion of the workload is moved to another of the cores.

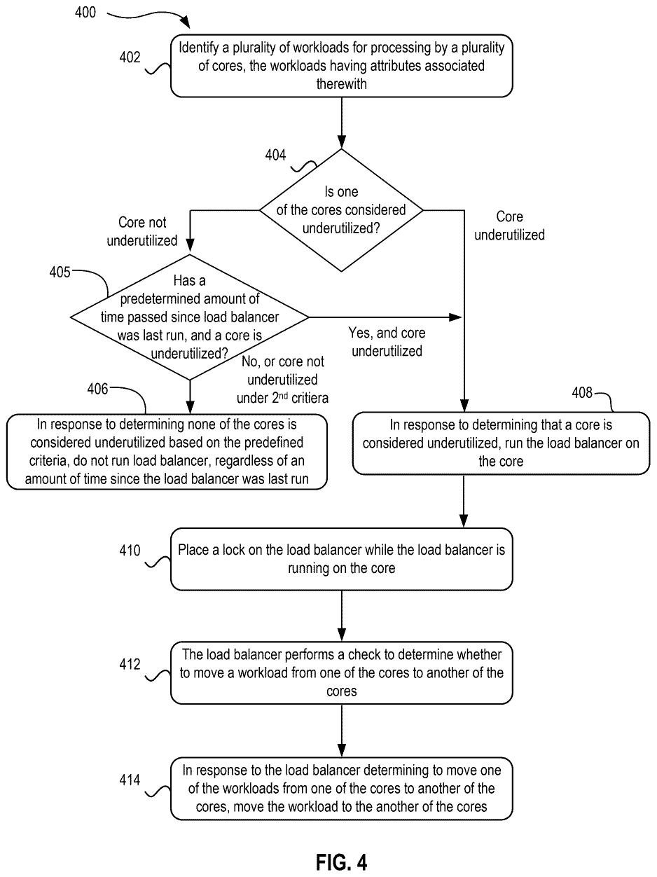

Now referring to FIG. 4, a flowchart of a method 400 is shown according to one approach. The method 400 may be performed in accordance with aspects of the present invention in any of the environments depicted in FIGS. 1-3, among others, in various approaches. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various approaches, the method 400 may be partially or entirely performed by a discrete processor having multiple cores, a cluster of discreet processors where each processor is considered a core, a cluster of multi-core processors which act as a larger processor having a combination of the cores from multiple processors, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a plurality of workloads for processing by a plurality of cores are identified. As in operation 302 of FIG. 3, the workloads have attributes associated therewith.

In operation 404, a determination is made as to whether one of the cores is considered underutilized based on predefined criteria.

In operation 405, a determination is made as to whether a predefined amount of time has passed since the load balancer was last run and whether one of the cores is considered underutilized based on second predefined criteria. The second predefined criteria may be similar to the criteria used in operation 404, or may be different e.g., may have a different threshold for what is considered underutilized. Thus, the load balancer may run less often, or not at all, while the cores remain sufficiently utilized. When a determination is made that one of the cores becomes underutilized, the load balancer may be run.

In operation 406, in response to determining none of the cores is considered underutilized based on the predefined criteria, the load balancer is not run, regardless of an amount of time since the load balancer was last run. However, in response to determining that a first of the cores is considered underutilized, the load balancer is run on the first core in operation 408. In operation 410, a lock is placed on the load balancer while the load balancer is running on the first core. The load balancer performs a check to determine whether to move a workload from one of the cores to another of the cores. See operation 412.

In operation 414, in response to the load balancer determining to move one of the workloads from one of the cores to another of the cores, at least a portion of the workload is moved to another of the cores. The load balancer does not rebalance workloads more frequently than a predefined time duration, The workloads with certain attributes, e.g., are better optimized to run on a single core or run more efficiently sharing a single core with other similar workloads, may be pinned to a common one of the cores. These workloads may be run infrequently or may not be performance sensitive and thus may benefit from running on a single core rather than being optimized to run on multiple cores. No core is assigned both the cache friendly workloads and the cache unfriendly workloads by the load balancer.

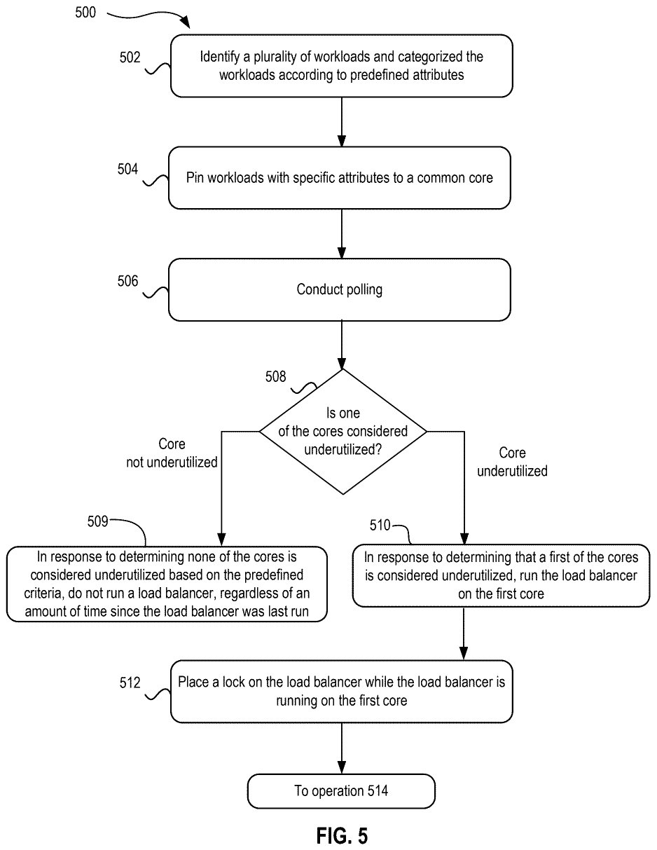

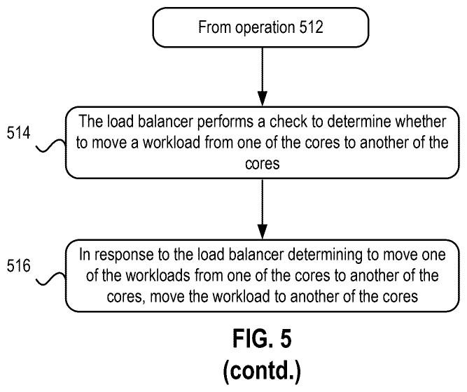

Now referring to FIG. 5, a flowchart of a method 500 is shown according to one approach. The method 500 may be performed in accordance with aspects of the present invention in any of the environments depicted in FIGS. 1-4, among others, in various approaches. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various approaches, the method 500 may be partially or entirely performed by a discrete processor having multiple cores, a cluster of discreet processors where each processor is considered a core, a cluster of multi-core processors which act as a larger processor having a combination of the cores from multiple processors, or some other device having one or more processors therein. The processor, e.g., processing circuit(s), chip(s), and/or module(s) implemented in hardware and/or software, and preferably having at least one hardware component, may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

Note also that the cores may be of a discrete processor having multiple cores, a cluster of discreet processors where each processor is considered a core, a cluster of multi-core processors which act as a larger processor having a combination of the cores from multiple processors, or some other device having one or more processors therein. The cores and/or processors may be of known construction, but are themselves or the environment they are in is adapted according to the teachings presented herein.

As shown in FIG. 5, method 500 may initiate with operation 502, where the various workloads are identified and categorized according to predefined attributes. In one approach, the attributes may be a specification of the type of workload, e.g., each workload is specified as a particular type, e.g., in a table. In some approaches, the predefined attributes may be any characteristics of the workloads that are useful in the given implementation. The attributes may be defined in any manner that would become apparent to one skilled in the art after reading the present disclosure, e.g., defined by a human, determined by software according to an algorithm programmed to determine the attributes and/or categorize the workloads according to predefined criteria, etc. Examples of attributes include indicators of resource utilizations of the workloads, such as whether the workloads are cache friendly or cache unfriendly (defined below); whether the associated workload is movable from core to core or non-movable (e.g., pinned to a core); a type of workload, e.g., each workload is associated with one of a plurality of predefined types of workloads; etc.

In a working example, described in various locations hereafter by way of example only, consider a Redundant Array of Independent Disks (RAID) storage adapter having seven types of work. These seven types of work are divided into cache friendly and cache unfriendly as well as movable and non-movable.

In preferred approaches, non-movable workloads are assigned to fixed cores. Moveable workloads may be dynamically moved between cores. Whether a workload is movable or non-movable may be predefined, specified by a programmer, etc. Further examples of how the determination to move a workload is done and how the move is done will be described later.

A scheduling mechanism may be implemented to schedule the running of workflows on the cores. In a preferred approach, the well-known scheduling mechanism known as event loops is used. This is light weight scheduling mechanism that eliminates the significant overhead incurred using operating system based scheduling.

Work (and accordingly its corresponding workload) may be dispatched in any desired manner, including in known ways. In various approaches, there are two methods by which work is dispatched. Some work comes from hardware responding to requests and/or may come from external sources adding entries onto queues. In the aforementioned working example, work may include hosts writing into request queues, sending instructions to a storage device, various hardware completions, etc. This work is polled. If the queue is dedicated to a core, every core that has a queue polls for completion on that queue. If the queue is not dedicated, only the cores assigned to that work poll the queue.

Other work is dispatched by software, potentially on a different core. In the aforementioned working example, such work may include requesting another core to perform some function such as perform a math function or build an NVMe op. This may also be done through queues called event queues (event loop scheduling mechanism), and thus are done on every core. However, the work sent to individual cores through event queues is controlled by work put on the event queues. The pieces of work placed on event queues are called events and the type of work is organized by work type called the event ID.

In software development, the 80-20 rule is often referred to, where 20% of the code is run 80% of the time and the other 80% of the code is only run 20% of the time. Often in embedded systems, such as RAID storage systems, this is closer to a 99-1 rule, and potentially more. In a storage system, reads and writes are run the vast majority of the time. Yet, error handling, data recovery, rebuilds, initialization, configuration changes, and the like are all critically important but rarely run.

Because so many of these things are almost never run, optimizing them to run across multiple cores may have a low priority. Accordingly, in operation 504, workloads with certain attributes, e.g., are better optimized to run on a single core or run more efficiently sharing a single core with other similar workloads, may be pinned to a common one of the cores. These workloads may be run infrequently or may not be performance sensitive and thus may benefit from running on a single core rather than being optimized to run on multiple cores. The workloads in the group may be pinned based on their known type, how they have been optimized, what data they touch, and may be added to the group dynamically if their attributes change, etc. In some approaches, this work may be pinned to this code simply to restrict the code and associated data to running on a single core. By assigning all of these workloads to one fixed core, the code can be greatly simplified. This work may be referred to as the “big task”.

A benefit of consolidating these low-demand processes into one task is that the task is by definition single threaded, meaning that no locks are needed because it is one task. The absence of locks removes the locking overhead mentioned elsewhere, thereby significantly improving performance. Likewise, other pieces of work may be pinned to a single core, e.g., this core or another core.

Note also that, other workloads may also be assigned to the common core during a balancing operation, while the pinned workloads remain pinned to the common core. Some other work is performance critical, but, if able to run without locks, is fairly efficient and can satisfy the system demands by only running on one core. In one approach, this work is also fixed to a single core much like in AMP, but other work is also allowed to use that core if necessary, and the balancing suggests that is the correct course of action.

In preferred embodiments, workflows are pre-classified as cache friendly or cache unfriendly, e.g., classified by a user who understands the various workflows. In other approaches, the workflows may be assessed dynamically, e.g., based on polling, attributes, observed or estimated cache usage, etc. The following guidance may be used to classify or pre-classify workflows as cache friendly or cache unfriendly.

Some workflows may touch vast amount of data. Workflows that overflow the cache, thereby affecting later workflows on the same core, are considered cache unfriendly. A cache unfriendly workload may, in some approaches, be a workload which touches a large amount of data with little or no reoccurring touches to the same data. These workloads have the expectation that after running them, much of the prior cache data will have been evicted. Examples of workflows that are typically cache unfriendly include data intensive workloads, such as calculating CRCs, XORing data from multiple buffers, etc. Of course, the thresholds for determining cache friendly and cache unfriendly workloads may be set to any desired value by the implementer of the system.

Workflows that are considered cache friendly may be those that do not significantly affect the data cache when used by subsequent workflows on the same core period. In some approaches, a cache friendly workload may touch some data but the expectation is that much of the previous cache contents will not be evicted when running the workload. For example, cache friendly workflows may evict lines from cache, but they are likely to touch smaller bits of data and tend to leave more common control blocks or data structures resident in cache across many requests.

In the working example of a storage adapter, performance critical work that touches vast amounts of data may include workloads that calculate cyclical redundancy checks (CRCs) and/or other data verification and/or error correction, multiplies data, or does other data transformations. This work tends to very quickly overflow both L1 and L2 cache. Often, just a single request will touch over 1 MB of data. Types of workloads such as these are considered cache unfriendly, as every request essentially ruins the cache for whatever workflow runs on that core next. In the working example, this work is optimized to run as efficiently as possible, but it still will ruin the cache for one or more later requests. Other work is more focused on control flow and more normal program behavior with respect to data accesses. This work is considered cache friendly. It may evict lines from cache, but it is likely to touch smaller bits of data and may leave more common control blocks or data structures resident in cache across many requests.

In a preferred approach, all work, including external requests on queues and software requests on work queues, are processed by polling. See operation 506. In some approaches, the main loop on each core simply polls a set of queues for work on those queues.

Preferably, the load balancer works based on continuously collected metrics and a set of rules to govern how work is moved around, as elaborated on below. In one approach, a timestamp is generated when work is assigned, and another timestamp is generated as work is completed. The time deltas calculated from the timestamps may be saved and/or accumulated for every type of work on each core. When a core is able to run the load balancer, it can use those values to determine how much processing each core has done and determine whether to rebalance workloads.

In operation 508, a determination is made as to whether one of the cores is considered underutilized based on predefined criteria. If none of the cores is underutilized, the load balancer is not run in some approaches. See operation 509. In operation 510, in response to determining that one of the cores is considered underutilized, the load balancer is run on the underutilized core. The load balancer is configured to perform a check to determine whether to move a workload from one or more of the cores to another core or cores. See operation 514. Examples follow.

The queues that are assigned to a core are processed and information corresponding thereto is gathered. In some approaches, for each core, the main loop processes the queues that are assigned to that core, be it fixed or dynamically assigned. Some types of queues may be lock protected and serviced by multiple cores, some queues may be fixed and assigned to just one core, and some queues may be unique to each core. Preferably, in all cases, the main loop on each core services every queue that is assigned to that core. When doing so, it keeps track of the time spent processing each queue. This time is accumulated in control blocks specific to the types of work and for each core.

In the working example, because all software-dispatched work goes through event queues, the time is accumulated in control blocks specific to the event ID. If a queue is checked but has no work on it, this is usually much faster, but it is a non-zero amount of time. This time is accumulated in an “idle time” control block specific to the type of work or event ID.

On an idle system or on a core which no longer has work going to it, this idle time can be very significant.

In one approach, if every queue checked had no work, the pass through the main loop is considered idle. Preferably, the methodology is configured such that the more idle a core is, the more likely the core will be to check whether a rebalance can be done.

In one approach, if a predetermined number of passes through the main loop on a given core are considered idle, extra checking may be done. In one example, upon detecting three consecutive idle passes, then if the total count has reached 1000, the process proceeds to the next check. In the next check, if eight consecutive and 10000 total idle passes are counted, checking the load balancer is initiated. If 8 and 10000 passes has not been reached, a check may be performed to determine if a re-balance should be performed. Essentially, this gives the load balancer a chance to be checked within some interval, e.g., at least once every 500 ms, at least once per second, etc., even if the core does not meet the full requirement for being underutilized.

Preferably, the load balancer does not rebalance workloads across the cores, or on a particular core, more frequently than a predefined time duration, e.g., corresponding to multiple clock cycles. Any time duration may be selected, e.g., 10 ms, 100 ms, 500 ms, etc. This prevents deterioration of system performance from cores checking the load balancer often. In one approach, when the load balancer is checked, it does a quick simple check to see if enough time has passed. In another approach, the core may decide whether it is underutilized enough to invoke the load balancer after the predefined time duration, e.g., periodically. If the core determines that it is not underutilized, e.g., has a utilization above some predefined value such as 50%, then the core will not invoke the load balancer. If all cores are busy (not considered underutilized), then in preferred approaches, none of the cores invoke the load balancer.

In the working example, the load balancer will not re-balance more than once every 100 ms. By ensuring it does not run too often and it only runs on a core that is sufficiently underutilized, the load balancer attempts to not be part of the problem on a busy system by being run when all cores are sufficiently busy and thus the system is likely balanced.

In a preferred approach, in response to determining none of the cores is considered underutilized based on predefined criteria, e.g., as described herein, the load balancer is not run, regardless of an amount of time since the load balancer was last run on any core. Thus, the load balancer may run less often, or not at all, while the cores remain sufficiently utilized. When a determination is made that one of the cores becomes underutilized, the load balancer may be run.

Even if a full second has passed and the utilization requirements are reduced, it is preferred that the core is at least somewhat idle for the load balancer to run. The rationale for requiring an underutilized or at least sufficiently underutilized core is that if no core is underutilized, every core is likely busy enough; thus no balancing is needed.

Note that in some less preferred approaches, the load balancer may be run at least periodically. For example, in response to determining that none of the cores was considered underutilized during a second predefined time duration, selecting one of the cores, and running the load balancer on the selected core in response to the second predefined time duration elapsing. This way, the load balancer can be checked at least periodically to determine whether any rebalancing would be beneficial.

Because the load balancer runs on an underutilized core, it can run on any core. Preferably, when run on a core, the load balancer is protected by a lock. See operation 512, where the load balancer is protected by a lock. In this way, if another core is also underutilized and attempts to check the load balancer, it will see that the lock is held and skip the attempt altogether, rather than spinning on the lock.

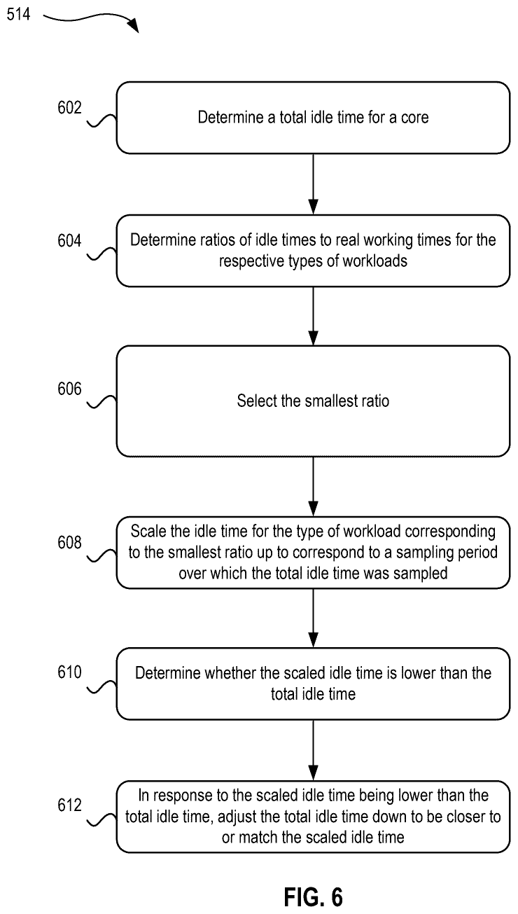

In one approach, as exemplified in the process of FIG. 6, operation 514 where the load balancer checks to determine whether to move a workload from one core to another includes a subprocess for adjusting the estimated idle time of a core to more accurately depict the true idle time of the core. The subprocess includes determining a total idle time for a core in operation 602. Operation 604 includes determining ratios of idle times to real working times for the respective types of workloads. Operation 606 includes selecting the smallest ratio. Operation 608 includes scaling the idle time for the type of workload corresponding to the smallest ratio up to correspond to a sampling period over which the total idle time was sampled. Operation 610 includes determining whether the scaled idle time is lower than the total idle time. In operation 612, in response to the scaled idle time being lower than the total idle time, the total idle time is adjusted down to be closer to or match the scaled idle time. Consider the following example.

In one exemplary approach, when the load balancer performs a check, it starts by collecting all of the timing data the poll loops accumulate for each core. This data is sorted according to the different types of work. For example, an event ID that causes an NVMe operation (op) to be dispatched will later cause that NVMe op completion to be processed. These two different pieces of work are not identical but they are both pieces of performing the same type of work, and thus are considered the same type of workload. Thus, all of these discrete bits from workloads of the same type are aggregated together. The load balancer then generates deltas (differences) from the last time it collected the data. In addition to the deltas, the load balancer also calculates the idle time and corresponding percentage, as well as the fixed work times and corresponding percentages. The fixed work time is time from any work that is fixed only to this core.

Continuing with the example, the load balancer next makes adjustments to the raw idle time. If multiple types of work are assigned to a core, the idle time is essentially the sum of all the idle time from each type of work. However, if the idle time for a given type of work is very low, idle time from some other workload could be seen as idle time on this core and the core could be incorrectly counted as more idle than it really is. Empirically, for the storage adapter in the working example, it was found that for idle work above 6% idle, this effect diminished to basically zero. However, below about 2%, it could have significant impact. To account for this, the work assigned to the core is examined to find the lowest idle ratio. That is, for each type of work, the ratio of idle time to real working time for that type of work was calculated and the smallest ratio is selected. If that smallest ratio is scaled up to the full duration of the sample (e.g., pretend this was the only work on the core) and the result was lower than the total idle time, then the idle time is adjusted down to match or be closer to the scaled idle time for this type of work.

In preferred approaches, the load balancer ensures that no core is assigned both cache friendly and cache unfriendly work. For example, in some implementations, at boot time, everything other than fixed work will be on one core, so the load balancer will move cache unfriendly work off of this core. This is a special case for boot time, and in some approaches, having both cache friendly and cache unfriendly work assigned to the same core at any other time is considered an error. It should be noted that if using simultaneous multithreading (SMT) or hyper-threading, cache impacts are associated with the physical core, not the logical core, so this processing may be done with respect to the physical cores when considering cache friendly and cache unfriendly work.

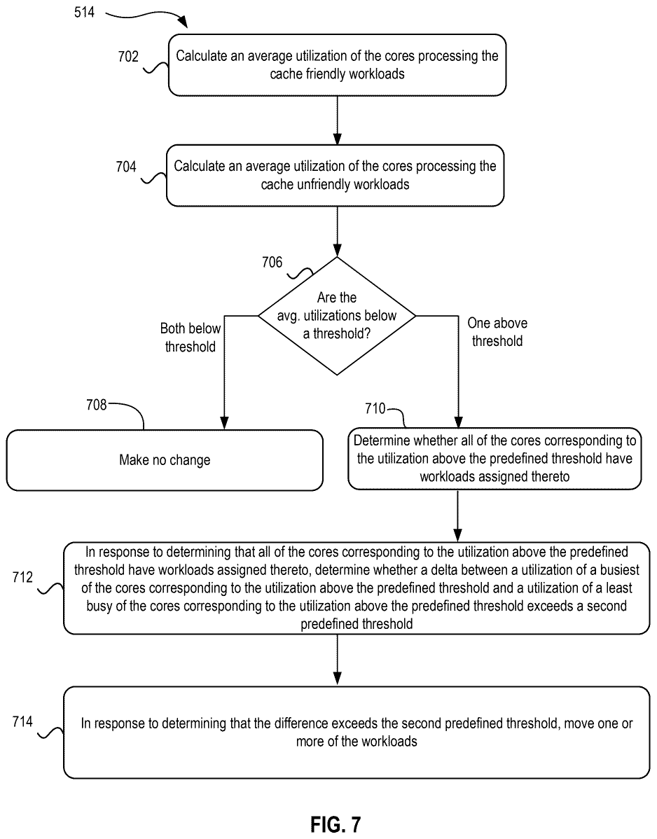

It is preferrable to avoid a situation where the highest utilized core is converted to the new lowest utilized core, thereby avoiding the overhead and processing delays associated with moving a workload from one core to another if little to no improvement to system performance would be gained by the move. Accordingly, in one approach, the checking by the load balancer in operation 514 of FIG. 5 includes a subprocess shown in FIG. 7. In operation 702, an average utilization of the cores processing the cache friendly workloads is calculated. Operation 704 includes calculating an average utilization of the cores processing the cache unfriendly workloads. Operation 706 includes determining whether the average utilizations are below a predefined threshold. In response to determining that both utilizations are below the predefined threshold, no change is made to the workloads. See operation 708. In response to determining that one of the utilizations is above the predefined threshold, a determination is made as to whether all of the cores corresponding to the utilization above the predefined threshold have workloads assigned thereto. See operation 710. In response to determining that all of the cores corresponding to the utilization above the predefined threshold have workloads assigned thereto, a determination is made as to whether a difference (delta) between a utilization of a busiest of the cores corresponding to the utilization above the predefined threshold and a utilization of a least busy of the cores corresponding to the utilization above the predefined threshold exceeds a second predefined threshold. See operation 712. In response to determining that the difference exceeds the second predefined threshold, a determination is made to move one or more of the workloads, preferably from the busiest core to another core, e.g., to the least busy core, to multiple less busy cores, etc. See operation 714.

In an exemplary approach, the load balancer calculates the average utilization of cache friendly cores and cache unfriendly cores. If they are both below a certain threshold, nothing is done. In the working example, this threshold is 50%, but in various approaches, could be any other desired value, such as 75%, 25%, etc. If either average utilization value is above that threshold, then the load balancer checks if there are any cores which have not been assigned work. If all cores have assigned work, the load balancer then checks if the delta between the average utilization exceeds a certain threshold. In the working example, this threshold is set to 15%, but in various approaches, could be any other desired value, such as 5%, 10%, 25%, etc. Next, the load balancer checks if the lowest utilized core is assigned to the lowest type of cache designation (friendly or unfriendly) and if so, assigns one or more workloads on that core for movement. If not, it means that the highest utilized type of cache designation also has the lowest utilized core and thus cache balancing is not going to help. Preferably, only one core will have assignments changed per load balancing cycle. This prevents overshooting or ping-ponging. This also reduces the potential performance degradation due to making too many moves. The frequency of invoking the load balancer is preferably frequent enough that the system will iterate quickly to optimization for the current state of the workloads.

In response to the load balancer determining to move one of the workloads from one of the cores to another of the cores, at least a portion of the workload is moved to another of the cores. See operation 516.

Moving the work may involve updating control blocks that control both the routing of event IDs to event queues and which queues should be polled in the main loop. The updating may be initiated by the load balancer, or other application.

Once cache friendly and unfriendly workloads are assessed, the work should be balanced between the types of cache friendly and unfriendly workloads on their respective cores. In the working example, there is only one type of cache unfriendly work so this is quite simple. In the working example, all of this work type may be assigned to every core. In general, this balancing is less important for cache unfriendly workloads. The benefits of workload coalescence and segregation is generally for purposes of cache and these workloads are, by definition, not cache friendly. However, in an implementation where something like an instruction cache could take advantage of better work segregation, the next section would apply the same for cache unfriendly work as it does for cache friendly work.

To balance cache friendly work, one approach first identifies the highest and lowest utilized cores assigned to cache friendly work. No changes are made unless the highest utilized core utilization exceeds a threshold and the delta between the highest and lowest utilization also exceeds a second threshold. The first and second thresholds may be any desired value. In the working example, these two thresholds are 50% and 15% respectively, but in various approaches, could be any other desired value, such as 75%, 25%, 10%, 5%, etc.

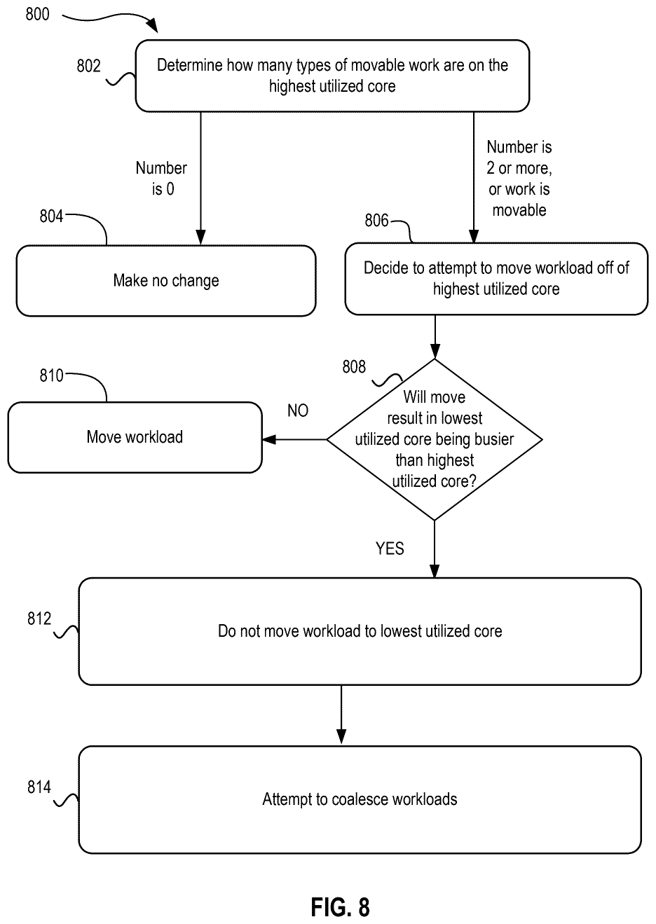

Next, in response to determining to move one or more of the workloads, the method 800 of FIG. 8 may be performed. Referring to FIG. 8, a flowchart of a method 800 is shown according to one approach. The method 800 may be performed in accordance with aspects of the present invention in any of the environments depicted in FIGS. 1-7, among others, in various approaches. Of course, more or fewer operations than those specifically described in FIG. 8 may be included in method 800, as would be understood by one of skill in the art upon reading the present descriptions.

Each of the steps of the method 800 may be performed by any suitable component of the operating environment. For example, in various approaches, the method 800 may be partially or entirely performed by a discrete processor having multiple cores, a cluster of discreet processors (preferably on a single board) where each processor is considered a core, a cluster of multi-core processors which act as a larger processor having a combination of the cores from multiple processors, or some other device having one or more processors therein. The processor, e.g., processing circuit(s), chip(s), and/or module(s) implemented in hardware and/or software, and preferably having at least one hardware component, may be utilized in any device to perform one or more steps of the method 800. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 8, method 800 may initiate with operation 802, where a determination is made of how many types of movable work are on the highest utilized core (busiest core). If the number is zero, then nothing is done. See operation 804. If the number is two or larger or movable and fixed work is assigned to the core, work may be moved off of the core. See operation 806. To move work off of a core, one approach finds and selects the type of movable workload that took the lowest processing time on the busiest core. It is preferable to move the smallest amount of work possible. In operation 808, a determination may then be made to ensure that moving this much work to the lowest utilized core will still result in the lowest core having lower utilization than the current highest core utilization. Said another way, a determination may be made as to whether moving the type of the movable workload having the lowest processing time on the busiest of the cores to the least busy of the cores would result in the least busy of the cores being busier than the busiest of the cores after the move. If the lowest utilized core will not be overutilized by the move, the workload is moved in operation 810. If the lowest utilized core will be overutilized by the move, then the workload is not moved to the lowest utilized (least busy) core. See operation 812. Rather, an attempt to coalesce work may be performed in operation 814. Coalescence is described in more detail below.

In response to determining that the number of types of workloads on the highest utilized core is exactly 1 and it is movable, an attempt may be made to spread the workloads of this type to another core such as the lowest utilized core, or possibly to the lowest utilized core and other cores. In a preferred approach, before the workloads are spread to more cores, a check is made to ensure that for the given type of workload, such reassignment will not exceed the prespecified maximum number of cores for this type of workload. Some types of work touch common data and thus may be protected by locks. In these cases, more cores will often help performance, but more cores will also introduce increasing lock contention. Too many cores can increase lock contention to the point where it dominates the time, resulting in performance decreasing. This point may be found empirically, estimated, or calculated for each workload with these characteristics. If the maximum number of cores for the type of workload will not be exceeded, the workload may be moved to the lowest utilized core, or workloads spread to one or more cores. In the case that the lowest utilized core is already working on that type of work, the move may be a no-op.

If it would be beneficial to coalesce work, such as when the lowest utilized core would be overutilized by a move as described above, the load balancer may perform a method 900 for coalescing workloads.

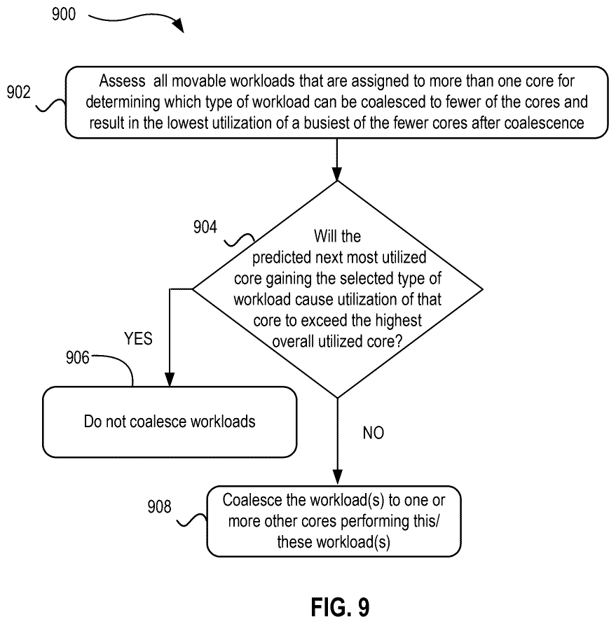

Next, in response to determining to move one or more of the workloads, the method 900 of FIG. 9 may be performed. Referring to FIG. 9, a flowchart of a method 900 is shown according to one approach. The method 900 may be performed in accordance with aspects of the present invention in any of the environments depicted in FIGS. 1-8, among others, in various approaches. Of course, more or fewer operations than those specifically described in FIG. 9 may be included in method 900, as would be understood by one of skill in the art upon reading the present descriptions.

Each of the steps of the method 900 may be performed by any suitable component of the operating environment. For example, in various approaches, the method 900 may be partially or entirely performed by a discrete processor having multiple cores, a cluster of discreet processors (preferably on a single board) where each processor is considered a core, a cluster of multi-core processors which act as a larger processor having a combination of the cores from multiple processors, or some other device having one or more processors therein. The processor, e.g., processing circuit(s), chip(s), and/or module(s) implemented in hardware and/or software, and preferably having at least one hardware component, may be utilized in any device to perform one or more steps of the method 900. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 9, method 900 may initiate with operation 902, where all movable workloads that are assigned to more than one core are assessed for determining which type of workload can be coalesced to fewer of the cores and result in the lowest utilization of a busiest of the fewer cores after coalescence. In one illustrative approach, for each type of workload, the utilization across all cores is totaled up. Then, the estimated average utilization is calculated as if one less core were working on these workloads. An assumption that the work would be removed from the highest utilized core may be made, and an estimate made of what the expected utilization would be on the next highest utilized core. This calculation may be performed for every work type assigned to more than one core to find the work type where the next most utilized core would result in the lowest utilization. Preferably, once this type of workload is identified, a determination is made as to whether the predicted next most utilized core gaining this additional burden (preferably with addition of a small margin of error) will not cause utilization of that core to exceed the highest overall utilized core. See operation 904. If the utilization of the next highest utilized core would exceed that of the highest utilized core, or is too close thereto (e.g., within a predefined range), then coalescing any workload would likely lower overall system performance by making that core worse by adding too much burden. Accordingly, workloads are not coalesced. See operation 906. If the burden can be absorbed by the remaining cores, the previously identified workload may be moved from the highest utilized core doing this type of work, thereby coalescing the workload to the remaining cores performing this workload in operation 908.

Once all the decisions of which cores will be adding or losing workloads is complete, the individual main loops may simply be processing the assigned queues when the control block updates propagate through the processor. Preferably, these control blocks are intentionally written only by the load balancer and read by the main loops, thus allows a lock-less design. There are also, preferably, no assumptions of “completion” on work movement. The changes may simply be reflected in the performance as the updates are consumed.

Note that in some approaches, however, for the event queues, the core assignments are not assessed in the main loop, but rather by the dispatch of the events to the event queues. This dispatch logic may be performed by a routing table. The intent is for this to be very light weight in terms of dispatch compute time so it is event ID-centric rather than core-centric. Thus, it is simpler and faster to update at the end of the balancing rather than during. Thus, upon finishing all of the balancing, this routing table is updated.

In preferred approaches, the load balancer has one or more of the following attributes.

The load balancer only runs on an underutilized core, e.g., having an average utilization below a predefined value during a sampling period. More preferably, most of the time it only runs on a relatively very underutilized core.

The load balancer only makes changes if at least one core is fairly busy, e.g., having an average utilization above a predefined value, such as 50%, over a sampling period.

The load balancer only makes changes if the utilization spread between the busiest core and the least busy core is significant, e.g., above a predefined threshold that results, on average, in a performance improvement.

The load balancer attempts to only move a workload if the move will be a net positive for this system, e.g., if the move will result in a performance improvement.

The load balancer attempts to move work before it coalesces work.

The load balancer keeps cache friendly and cache unfriendly work separated.

The load balancer dynamically adjusts to changing workloads.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described aspects. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
identifying a plurality of workloads for processing by a plurality of cores, the workloads having attributes associated therewith, the attributes including whether the associated workload is movable or non-movable, the attributes including indicators of resource utilizations of the workloads;
determining whether one of the cores is considered underutilized based on predefined criteria;
in response to determining that a first of the cores is considered underutilized, running a load balancer on the first core,
wherein the load balancer performs a check to determine whether to move a workload from one of the cores to another of the cores; and
in response to the load balancer determining to move one of the workloads from one of the cores to another of the cores, moving at least a portion of said workload to the another of the cores.

2. The method of claim 1, wherein the load balancer does not rebalance workloads more frequently than a predefined time duration.

3. The method of claim 2, wherein in response to determining that none of the cores was considered underutilized during a second predefined time duration, selecting one of the cores, and running the load balancer on the selected core.

4. The method of claim 1, in response to determining none of the cores is considered underutilized based on the predefined criteria, not running the load balancer, regardless of an amount of time since the load balancer was last run.

5. The method of claim 1, comprising pinning some workloads with certain attributes to a common one of the cores.

6. The method of claim 5, wherein other workloads are also assigned to the common core during a balancing operation.

7. The method of claim 1, further comprising:
placing a lock on the load balancer while the load balancer is running on the first core.

8. The method of claim 1, wherein the checking by the load balancer includes:
determining a total idle time for the first core;
determining ratios of idle times to real working times for the respective types of workloads;
selecting the smallest ratio;
scaling the idle time for the type of workload corresponding to the smallest ratio up to correspond to a sampling period over which the total idle time was sampled;
determining whether the scaled idle time is lower than the total idle time; and
in response to the scaled idle time being lower than the total idle time, adjusting the total idle time down.

9. The method of claim 1, wherein the indicators of resource utilizations of the workloads indicate whether the associated workloads are cache friendly or cache unfriendly, wherein no core is assigned both the cache friendly workloads and the cache unfriendly workloads by the load balancer.

10. The method of claim 9, wherein the checking by the load balancer includes:
calculating an average utilization of the cores processing the cache friendly workloads;
calculating an average utilization of the cores processing the cache unfriendly workloads;
determining whether the average utilizations are below a predefined threshold;
in response to determining that both utilizations are below the predefined threshold, making no change to the workloads;
in response to determining that one of the utilizations is above the predefined threshold, determining whether all of the cores corresponding to the utilization above the predefined threshold have workloads assigned thereto;
in response to determining that all of the cores corresponding to the utilization above the predefined threshold have workloads assigned thereto, determining whether a difference between a utilization of a busiest of said cores corresponding to the utilization above the predefined threshold and a utilization of a least busy of said cores corresponding to the utilization above the predefined threshold exceeds a second predefined threshold; and
in response to determining that the difference exceeds the second predefined threshold, determining to move one or more of the workloads.

11. The method of claim 10, comprising:
in response to determining to move one or more of the workloads, determining how many types of the movable workloads are on the busiest of said cores;
in response to determining that a number of types of the movable workloads on the busiest of said cores is at least two, selecting the type of the movable workloads having the lowest processing time on the busiest of said cores;
determining whether moving the type of the movable workload having the lowest processing time on the busiest of said cores to the least busy of said cores would result in the least busy of said cores being busier than the busiest of said cores after said move;
in response to determining that the least busy of said cores would be busier than the busiest of said cores after said move, not moving the type of the movable workload having the lowest processing time on the busiest of said cores; and
in response to determining that the least busy of said cores would not be busier than the busiest of said cores after said move, moving the type of the movable workload having the lowest processing time on the busiest of said cores to the least busy of said cores.

12. The method of claim 10, comprising:
in response to determining to move one or more of the workloads, determining how many types of the movable workloads are on the busiest of said cores; and
in response to determining that a number of types of the movable workloads on the busiest of said cores is one, moving at least a portion of one of the movable workloads from the busiest of said cores to at least one other core.

13. The method of claim 1, wherein the checking by the load balancer includes attempting to coalesce at least some of the movable workloads, the checking comprising:
assessing the types of movable workloads that are assigned to multiple cores for determining which type of workload can be coalesced to fewer of the cores and result in the lowest utilization of a busiest of said fewer cores after coalescence; and
based on the assessment, coalescing the workloads of the determined type to the fewer of the cores.

14. A computer program product comprising:
one or more computer-readable storage media; and
program instructions stored on the one or more storage media to perform operations comprising:
identifying a plurality of workloads for processing by a plurality of cores, the workloads having attributes associated therewith, the attributes including whether the associated workload is movable or non-movable, the attributes including indicators of resource utilizations of the workloads;
determining whether one of the cores is considered underutilized based on predefined criteria;
in response to determining that a first of the cores is considered underutilized, running a load balancer on the first core,
wherein the load balancer performs a check to determine whether to move a workload from one of the cores to another of the cores; and
in response to the load balancer determining to move one of the workloads from one of the cores to another of the cores, moving at least a portion of said workload to the another of the cores.

15. The computer program product of claim 14, wherein the load balancer does not rebalance workloads more frequently than a predefined time duration, wherein in response to determining that none of the cores was considered underutilized during a second predefined time duration, selecting one of the cores, and running the load balancer on the selected core.

16. The computer program product of claim 14, wherein the operations further comprise:
in response to determining that none of the cores is considered underutilized based on the predefined criteria, not running the load balancer, regardless of an amount of time since the load balancer was last run.

17. The computer program product of claim 14, wherein some workloads with certain attributes are pinned to a common one of the cores.

18. The computer program product of claim 17, wherein other workloads are also assigned to the common core during a balancing operation.

19. The computer program product of claim 14, wherein the operations further comprise:
placing a lock on the load balancer while the load balancer is running on the first core.

20. The computer program product of claim 14, wherein the checking by the load balancer includes:
determining a total idle time for the first core;
determining ratios of idle times to real working times for the respective types of workloads;
selecting the smallest ratio;
scaling the idle time for the type of workload corresponding to the smallest ratio up to correspond to a sampling period over which the total idle time was sampled;
determining whether the scaled idle time is lower than the total idle time; and
in response to the scaled idle time being lower than the total idle time, adjusting the total idle time down.

21. The computer program product of claim 14, wherein the indicators of resource utilizations of the workloads include designations of whether the workloads are cache friendly or cache unfriendly, wherein no core is assigned both the cache friendly workloads and the cache unfriendly workloads by the load balancer.

22. A computer system comprising:
a processor set;
one or more computer-readable storage media; and
program instructions stored on the one or more storage media to cause the processor set to perform operations comprising:
identifying a plurality of workloads for processing by a plurality of cores, the workloads having attributes associated therewith, the attributes including whether the associated workload is movable or non-movable, the attributes including indicators of resource utilizations of the workloads;
determining whether one of the cores is considered underutilized based on predefined criteria;
in response to determining that a first of the cores is considered underutilized, running a load balancer on the first core,
wherein the load balancer performs a check to determine whether to move a workload from one of the cores to another of the cores; and
in response to the load balancer determining to move one of the workloads from one of the cores to another of the cores, moving at least a portion of said workload to the another of the cores.

23. The computer system of claim 22, wherein the indicators of resource utilizations of the workloads include designations of whether the workloads are cache friendly or cache unfriendly, wherein no core is assigned both the cache friendly workloads and the cache unfriendly workloads by the load balancer.

24. A method comprising:
identifying a plurality of workloads for processing by a plurality of cores, the workloads having attributes associated therewith, the attributes including whether the associated workload is movable or non-movable, the attributes including whether the associated workload is cache friendly or cache unfriendly;
determining whether one of the cores is considered underutilized based on predefined criteria;
in response to determining none of the cores is considered underutilized based on the predefined criteria, not running a load balancer, regardless of an amount of time since the load balancer was last run;
in response to determining that a first of the cores is considered underutilized, running the load balancer on the first core;
placing a lock on the load balancer while the load balancer is running on the first core,
wherein the load balancer performs a check to determine whether to move a workload from one of the cores to another of the cores;
in response to the load balancer determining to move one of the workloads from one of the cores to another of the cores, moving at least a portion of said workload to the another of the cores; and
pinning some workloads with certain attributes to a common one of the cores while the other workloads may be moved to other cores including the common one of the cores,
wherein the load balancer does not rebalance workloads more frequently than a predefined time duration,
wherein no core is assigned both the cache friendly workloads and the cache unfriendly workloads by the load balancer.

25. A computer program product comprising:
one or more computer-readable storage media; and
program instructions stored on the one or more storage media to perform operations comprising:
identifying a plurality of workloads for processing by a plurality of cores, the workloads having attributes associated therewith, the attributes including whether the associated workload is movable or non-movable, the attributes including whether the associated workload is cache friendly or cache unfriendly;
determining whether one of the cores is considered underutilized based on predefined criteria;
in response to determining none of the cores is considered underutilized based on the predefined criteria, not running a load balancer, regardless of an amount of time since the load balancer was last run;
in response to determining that a first of the cores is considered underutilized, running the load balancer on the first core;
placing a lock on the load balancer while the load balancer is running on the first core;
wherein the load balancer performs a check to determine whether to move a workload from one of the cores to another of the cores;
in response to the load balancer determining to move one of the workloads from one of the cores to another of the cores, moving at least a portion of said workload to the another of the cores; and
pinning some workloads with certain attributes to a common one of the cores while the other workloads may be moved to other cores including the common one of the cores,
wherein the load balancer does not rebalance workloads more frequently than a predefined time duration,
wherein no core is assigned both the cache friendly workloads and the cache unfriendly workloads by the load balancer.
